(19) United States
(12) Patent Application Publication
(10) Pub. No.: US 2006/0050944 A1
(43) Pub. Date: Mar. 9, 2006

(54) Nipple detection apparatus and program

(75) Inventors: Hideya Takeo, Kanagawa-ken (JP); Chou Shi, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/216,146

(22) Filed: Sep. 1, 2005

(30) Foreign Application Priority Data
Sep. 3, 2004 (JP) 257199/2004

(51) Int. Cl. G06K 9/00

(52) U.S. Cl. 382/132

(57) ABSTRACT

The outline of a breast is detected based on breast image data representing a breast image obtained by photographing the breast. Then, a nipple projection portion, which locally projects outward from the outline of the breast, is detected based on the information about the outline of the breast.

### BACKGROUND OF THE INVENTION

1. Field of the Invention

The present invention relates to a nipple detection apparatus and program.

2. Description of the Related Art

Conventionally, a system (abnormal shadow candidate detection system) for assisting radiologists in making diagnoses has been developed. In this system, digital image signals obtained, for example, by performing radiographic photography on breasts are analyzed using a computer to automatically detect abnormal shadows such as a tumor shadow or microcalcification shadow, that appear in images. Accordingly, even if the images are diagnosed by an unskilled radiologist, a sufficient detection level can be maintained.

This system is mainly used to automatically detect tumor shadow candidates in radiographic images (mammograms) of breasts, that are obtained in breast cancer screening. The tumor shadow candidates are detected by evaluating the degrees of convergence of gradient vectors of density (signal values) in digital image signals which represent the radiographic images. Alternatively, candidates for abnormal shadows such as a tumor shadow or microcalcification shadow are detected by algorithm for automatically detecting microcalcification shadow candidates. The microcalcification shadow candidates are detected by performing morphology operation (dilation processing, erosion processing, opening processing, closing processing, or the like) on the digital image signals. The abnormal shadow candidates detected by this system may be displayed on a CRT (cathode ray tube), liquid crystal display device, or the like, for example, by masking the mammograms with an ROI (region of interest) frame which has a rectangular shape. The abnormal shadow candidates may be also printed on diagnostic films, and provided for the radiologists.

When the radiologists or the like examine the mammograms including abnormal shadow candidates detected by the abnormal shadow candidate detection system, as described above, a pair of left and right breast images is often displayed simultaneously by arranging them back to back. For example, when an abnormal shadow candidate is detected in one of the left and right breast images, the other image is displayed to check whether an abnormal shadow candidate is also present at a similar position in the other image. Further, in mammography, breasts are photographed in both vertical and horizontal directions. The breast images photographed from the vertical direction are called front images (ML view (Medio-lateral view) or MLO view (Medio-lateral oblique view)). The breast images photographed from the horizontal direction are called side images (CC view (Cranio-caudal view)). Therefore, in some cases, a radiologist displays both of the front image and the side image of one of the left and right breasts side by side, and examines the images by comparing them with each other.

However, when two breast images are simultaneously displayed by arranging them back to back to compare them with each other, as described above, there are cases where the images are displayed in a manner that corresponding positions in the subjects of both of the images are not aligned with respect to a horizontal direction or vertical direction. When the positions are not aligned, there is a problem that it is difficult for the radiologists to compare and examine the images. Therefore, a method has been proposed in which two mammograms are displayed on a display screen of the system to compare them with each other. In this method, the images of the left and right breasts are positioned so that corresponding positions (for example, nipples) in both of the images are aligned with respect to the vertical direction (for example, Japanese Unexamined Patent Publication No. 2002-065613).

Further, there is also a method for positioning the images by detecting the highest point of a breast region in each of the left and right breast images, and by assuming that the highest point is a nipple.

The method of detecting the highest point, as described above, may be applied to images of a CC direction. However, in images of an MLO direction, the nipples are not the highest points in many cases. Therefore, if the highest point is simply detected as the nipple, it is impossible to accurately position the images.

### SUMMARY OF THE INVENTION

In view of the foregoing circumstances, it is an object of the present invention to provide a nipple detection apparatus and program for accurately detecting a nipple in a breast image.

A nipple detection apparatus according to the present invention is a nipple detection apparatus comprising:
an outline detection means for detecting, based on breast image data representing a breast image obtained by photographing a breast, the outline of the breast in the breast image; and
a nipple detection means for detecting, based on information about the outline of the breast, detected by the outline detection means, a nipple projection portion, which locally projects outward from the outline of the breast.

A program according to the present invention is a program for causing a computer to function as an outline detection means for detecting, based on breast image data representing a breast image obtained by photographing a breast, the outline of the breast in the breast image and a nipple detection means for detecting, based on information about the outline of the breast, detected by the outline detection means, a nipple projection portion, which locally projects outward from the outline of the breast.

The expression “locally projects outward from the outline of the breast” refers to a convex shape that further projects from the outline of the breast, which has a gradual outward convex shape as a whole.

Further, the nipple detection means may obtain a smoothed outline of the breast corresponding to a local portion of the outline of the breast, and detect the nipple projection portion based on a distance value between the smoothed outline of the breast and the portion of the outline of the breast.

The nipple detection means may obtain the smoothed outline of the breast by connecting both ends of the portion of the outline with a straight line, produce a plurality of pairs of the portions of the outline and the straight lines connecting both ends of the portions of the outline by gradually shifting the position of the portion of the outline along the outline of the breast, and detect the nipple projection portion based on the distance value between the portion of the outline and the straight line in each of the plurality of produced pairs.

The term “distance value” refers to a value representing a distance between the smoothed outline of the breast and the portion of the actual outline. For example, a distance between the center of the portion of the outline and the straight line connecting both ends of the portion of the outline may be used as the distance value (the center of the portion of the outline is a point on the portion of the outline, which is apart from an end of the portion of the outline by a half of the length of the portion of the outline along the portion of the outline).

Further, the nipple detection means may detect the nipple projection portion by performing top-hat transform on the outline of the breast from the inside of the region of the breast.

The expression “performing top-hat transform on the outline of the breast from the inside of the region of the breast” refers to transforming the outline of the breast into a shape that includes only a convexity that a structural element cannot enter. In the top-hat trans form, opening processing is performed along the outline of the breast using the structural element from the inside of the region of the breast, and a shape in which the convexity that the structural element cannot enter is removed from the outline of the breast. Then, the produced shape is subtracted from the outline of the breast to obtain the shape that includes only the convexity.

Further, the nipple detection means detects the nipple projection portion based on a second derivative value of the outline of the breast.

The term “second derivative value of the outline of the breast” refers to a value that can be used to detect a portion of the outline, in which the shape of the outline sharply changes. The value may be obtained using an equation. Alternatively, the value may be obtained by calculating a difference between the positions of adjacent pixels on the outline of the breast. For example, when the shape of the outline gradually changes, the “second derivative value” is approximately constant. However, when the shape of the outline sharply changes, the “second derivative value” increases. Therefore, the convexity of the outline, such as the nipple, may be detected based on the second derivative value.

According to the present invention, the outline of the breast is detected based on breast image data representing a breast image obtained by photographing a breast, and a nipple projection portion, which locally projects outward from the outline of the breast, is detected as a nipple. Therefore, the nipple can be accurately detected.

Further, a smoothed outline of the breast is obtained by smoothing the shape of the outline of the breast, and a distance value between the smoothed outline of the breast and the outline of the breast is obtained. Therefore, the portion that projects from the outline of the breast may be detected as the nipple.

Further, if the nipple is detected based on the distance value between the portion of the outline, which is a portion of the outline of the breast, and the straight line connecting both ends of the portion of the outline, the operation amount for detecting the nipple can be reduced. Further, the nipple can be accurately detected.

Alternatively, when the nipple projection portion is detected by performing top-hat transform on the outline of the breast from the inside of the region of the breast, if the size of the structural element is optimized, it is possible to detect only a projection which has a likely size of a nipple.

Further, if the nipple projection portion is detected based on a second derivative value of the outline, it is possible to detect only a projection which has a likely shape of a nipple.

Note that the program of the present invention may be provided being recorded on a computer readable medium. Those who are skilled in the art would know that computer readable media are not limited to any specific type of device, and include, but are not limited to: floppy disks, CD's RAM'S, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a schematic diagram illustrating the configuration of a nipple detection apparatus according to a first embodiment;

FIG. 2 is a diagram illustrating a result of binarization of a breast image;

FIG. 3 is a histogram of pixel values that appear in the breast image;

FIG. 4 is a diagram for explaining a method for detecting a skin line;

FIG. 5 is a diagram for explaining detection of a nipple projection portion using a portion of an outline along the skin line and a straight line connecting both ends of the portion of the outline;

FIG. 6 is a schematic diagram illustrating the configuration of a nipple detection apparatus according to a second embodiment;

FIG. 7A is a diagram for explaining detection of the nipple projection portion by top-hat transform;

FIG. 7B is a diagram for explaining detection of the nipple projection portion by top-hat transform;

FIG. 8 is a schematic diagram illustrating the configuration of a nipple detection apparatus according to a third embodiment;

FIG. 9A is a diagram for explaining detection of the nipple projection portion using second derivatives; and

FIG. 9B is a diagram for explaining detection of the nipple projection portion using the second derivatives.

### DESCRIPTION OF THE PREFERRED EMBODIMENTS

Hereinafter, a first embodiment of a nipple detection apparatus according to the present invention will be described with reference to attached drawings.

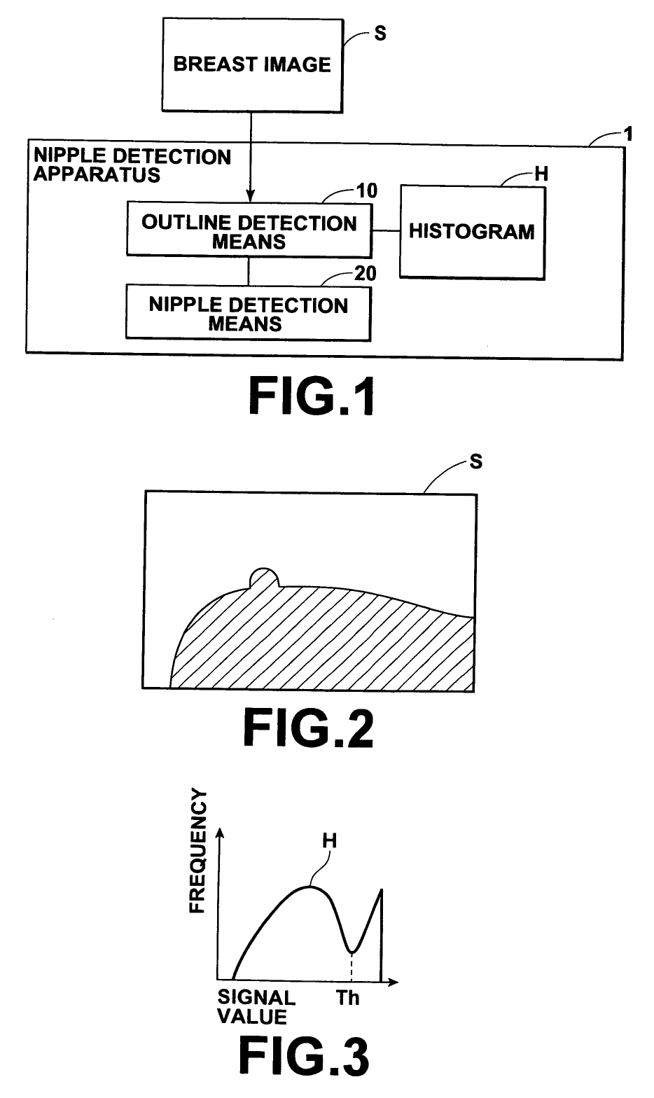

As illustrated in FIG. 1, a nipple detection apparatus 1 includes an outline detection means 10 for detecting the outline of a breast in a breast image S obtained by photographing a breast. The nipple detection apparatus 1 also includes a nipple detection means 20 for detecting a nipple projection portion, in which the outline of the breast projects from the region of the breast, as a nipple.

The outline detection means 10 detects, based on a histogram H of the breast image S, the outline of the breast in the breast image that is obtained by photography. As illustrated in FIG. 3, the peak of pixel values is different between pixels in the region of the breast and those in the background region. The peak of the pixel values in the region of the breast is present around at the center of the histogram, and the peak of the pixel values in the background region is present in the right side of the histogram. Therefore, binary processing is performed on the image using a threshold value Th that represents a boundary signal between the region of the breast and the background region. Accordingly, the binarized breast image S is divided into the region of the breast (shaded area) and the background region, as illustrated in FIG. 2.

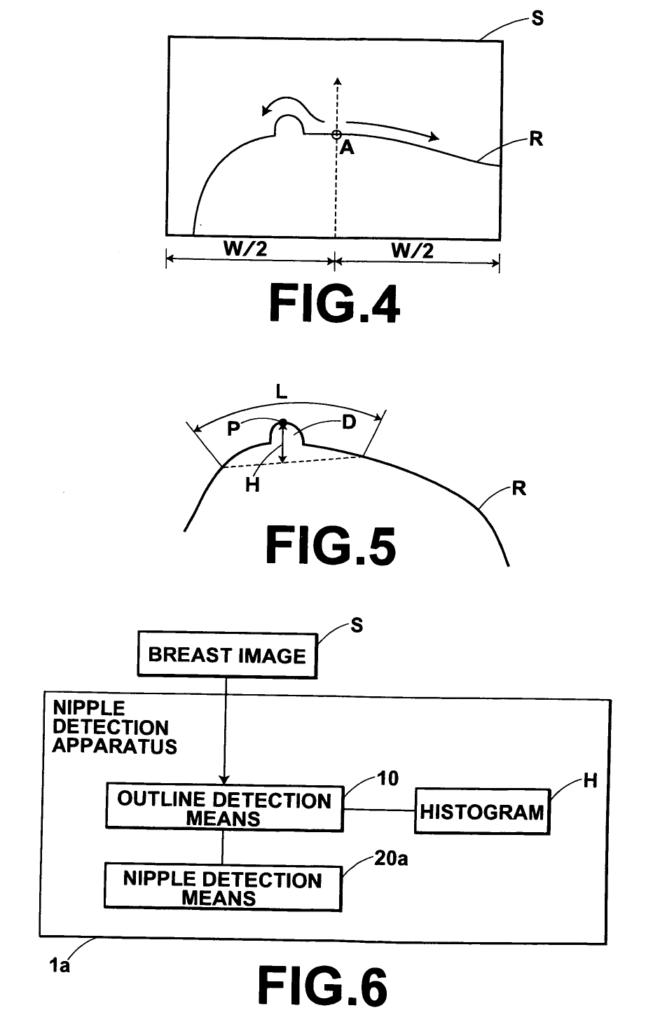

When the chest wall of the binarized breast image S is located in the lower side of the image, as illustrated in FIG. 4, the image is searched upward from the bottom of the image along a line (broken line) that passes through the center (W/2) of the width W of the image. Then, a point at which the region of the breast is changed to the background region is detected as point A. Further, the image is searched from point A toward both right and left sides to detect the outline R (hereinafter, referred to as a skin line) of the breast. For example, processing starts at point A, and continues in both right and left sides of point A. A pixel which is a border of the binary image is sequentially detected in pixels which are adjacent to point A, and the detected pixels are connected to each other to form a skin line R.

First, the nipple detection means 20 obtains a smoothed outline of a breast by smoothing the outline of the breast. Then, the nipple detection means 20 detects a nipple projection portion based on a distance value between the smoothed outline of the breast and the outline of the breast. Specifically, as illustrated in FIG. 5, a curve (a portion of the outline) which has a length L along the detected skin line R is set. Then, a straight line that connects both ends of the curve is used as the smoothed outline of the breast, and a distance H between the straight line and the center of the curve is obtained. A plurality of curves which have a length L is set by gradually shifting the position of the curve, and the distance H between the straight line and the center P of the curve is obtained for each of the curves. Then, the nipple projection portion D is detected by assuming that it is present in the vicinity of a center point P when the value H/L is the largest. The width of shifting the curve which has the length L is set, based on statistical sizes of nipples, so that at least one of the centers of the curves is positioned on the skin line R of the nipple projection portion.

For example, when there are 200 pixels on the skin line R, ten pixels may be selected in each time while gradually shifting the selecting position of the pixels along the skin line R. Then, an average (or, a weighted average in which a predetermined weight is given) of the coordinates of ten pixels may be obtained for each set of ten pixels, and points positioned at coordinates which have the obtained average values may be connected to obtain a smoothed outline of the breast. A distance between the smoothed outline of the breast and a point on the skin line R may be obtained to detect the nipple projection portion. In this case, the number of pixels for obtaining the average of the coordinate values is determined based on the statistical sizes of the nipple projection portions so that the nipple projection portion, which projects from the skin line R, is removed.

Alternatively, the smoothed outline of the breast may be obtained by interpolating a curve represented by a polynominal such as a spline between pixels on the skin line R. Then, a distance between the smoothed outline of the breast and the skin line R may be obtained to detect the nipple projection portion. Specifically, pixels on the skin line R are selected in a predetermined interval, and a curve is interpolated between the selected pixels using a spline or the like. Accordingly, a line in which the nipple projection portion is removed from the skin line R is obtained as the smoothed outline of the breast. When the pixels on the skin line R are selected in the predetermined interval, if a pixel on the nipple projection portion is selected, a curve is interpolated along the nipple. Therefore, it is preferable that interpolation is performed so that a pixel is not selected from a region of the image, in which the probability that a nipple is present is high, by considering the statistical sizes and positions of the nipple projection portions.

Especially, when the nipple projection portion is detected by setting a curve (portion of the outline) which has the length L along the skin line R and by obtaining a distance H between the straight line connecting both ends of the curve and the center of the curve, the operation amount for detecting the nipple projection portion can be reduced. Further, the nipple projection portion can be detected sufficiently accurately.

Next, a second embodiment of the present invention will be described.

In the second embodiment, the same reference numerals are given to the same elements as those in the previous embodiment, and detailed description thereof is omitted.

As illustrated in FIG. 6, a nipple detection apparatus 1a includes the outline detection means 10 for detecting the outline of a breast from a breast image obtained by photographing the breast. The nipple detection apparatus 1a also includes a nipple detection means 20a for detecting a nipple projection portion, in which the outline of the breast projects from the region of the breast, as a nipple.

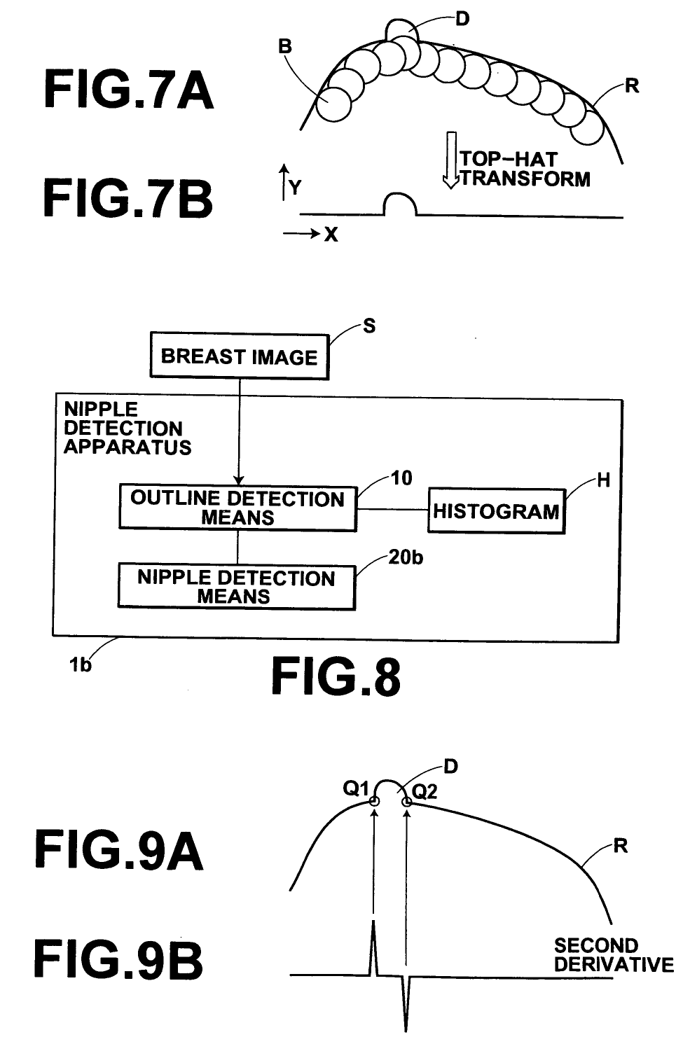

The nipple detection means 20a performs top-hat transform on the skin line R, illustrated in FIG. 7A, that is detected by the outline detection means 10 (please refer to FIG. 7A). The top-hat transform is performed using a structural element B which has a circular shape. The size of the structural element B is determined based on the statically obtained sizes of the nipples so that the structural element B does not enter the nipple projection portion. Accordingly, a shape in which only pixels in the nipple portion have coordinate values with respect to the Y direction is obtained, as illustrated in FIG. 7B. The convexity which has coordinate values with respect to the Y direction is detected as the nipple projection portion D.

Next, a third embodiment will be described.

As illustrated in FIG. 8, a nipple detection apparatus 1b includes the outline detection means 10 for detecting the outline of the breast from the breast image obtained by photographing the breast. The nipple detection apparatus 1b also includes a nipple detection means 20b for detecting a convex region in which the outline of the breast projects from the region of the breast as a nipple.

The nipple detection means 20b obtains second derivative values with respect to a skin line, as illustrated in FIG. 9A, that is detected by the outline detection means 10. The second derivative values are substantially constant in the region other than the nipple, as illustrated in FIG. 9B. However, the second derivative values sharply change at the boundaries (Q1 and Q2) between the nipple region and the other region. The nipple detection means 20b detects the nipple projection portion D by using the points at which the second derivative values change as a beginning Q1 of the nipple and an end Q2 of the nipple.

As described above in detail, it is possible to accurately detect the nipple by detecting a portion that locally projects outward from the outline of the breast.

Further, the detection method as described above in each of the embodiments may be combined to more accurately detect the nipple.

What is claimed is:

1. A nipple detection apparatus comprising:
an outline detection means for detecting, based on breast image data representing a breast image obtained by photographing a breast, the outline of the breast in the breast image; and
a nipple detection means for detecting, based on information about the outline of the breast, detected by the outline detection means, a nipple projection portion, which locally projects outward from the outline of the breast.

2. A nipple detection apparatus as defined in claim 1, wherein the nipple detection means obtains a smoothed outline of the breast corresponding to a local portion of the outline of the breast, and detects the nipple projection portion based on a distance value between the smoothed outline of the breast and the portion of the outline of the breast.

3. A nipple detection apparatus as defined in claim 2, wherein the nipple detection means obtains the smoothed outline of the breast by connecting both ends of the portion of the outline with a straight line, produces a plurality of pairs of the portions of the outline and the straight lines connecting both ends of the portions of the outline by gradually shifting the position of the portion of the outline along the outline of the breast, and detects the nipple projection portion based on a distance value between the portion of the outline and the straight line in each of the plurality of produced pairs.

4. A nipple detection apparatus as defined in claim 1, wherein the nipple detection means detects the nipple projection portion by performing top-hat transform on the outline of the breast from the inside of the region of the breast.

5. A nipple detection apparatus as defined in claim 1, wherein the nipple detection means detects the nipple projection portion based on a second derivative value of the outline of the breast.

6. A program for causing a computer to function as an outline detection means for detecting, based on breast image data representing a breast image obtained by photographing a breast, the outline of the breast in the breast image and a nipple detection means for detecting, based on information about the outline of the breast, detected by the outline detection means, a nipple projection portion, which locally projects outward from the outline of the breast.
